(19) United States
(12) Patent Application Publication
(10) Pub. No.: US 2004/0177322 A1
(43) Pub. Date: Sep. 9, 2004

(54) Apparatus, system and method of automatically placing embedded icons in their visual order in a displayed or printed bi-directionally formatted document

(75) Inventor: Steven Edward Atkin, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 10/378,379

(22) Filed: Mar. 3, 2003

(51) Int. Cl. G06F 15/00

(52) U.S. Cl. 715/513

(57) ABSTRACT

A system, apparatus and method of automatically placing embedded images or icons in their visual order in a displayed or printed bi-directionally formatted HTML document. The system, apparatus and method includes assigning a directional attribute to each image tag embedded in an HTML document. Then, the HTML document is processed by a bi-directional algorithm that specifies a visual order location for each one of the tags in the HTML document. Finally, each of the image tags are placed in the specified location before passing the HTML document to a browser to be displayed or printed.

### BACKGROUND OF THE INVENTION

1. Technical Field

The present invention is directed to document formatting. More specifically, the present invention is directed to an apparatus, system and method of automatically placing embedded icons or images in their visual order in a displayed or printed bi-directionally formatted document.

2. Description of Related Art

Some languages are bi-directional. That is, the languages provide for some content of a document to be written from a right-to-left direction (e.g., text) and for other content to be written from a left-to-right direction (e.g., numbers). However, the content of a document written in a bi-directional language is ordinarily stored on a computer system in a logical order rather than a visual order. A logical order is the order in which one would normally type a text into a computer system. A visual order, on the other hand, is the order in which a bi-directional document may be printed or rendered on a computer screen. For example, if the word PATENT were to be typed into a right-to-left formatted document, it would be typed in as P A T E N T, its logical order. However, when displayed on the screen or printed, it would appear as T N E T A P, its visual order.

As is well known in the field, the HyperText Markup Language (HTML) is the authoring language used to create documents on the World Wide Web (Www) HTML defines the structure and layout of a Web document by using a variety of tags and attributes. HTML supports bi-directional text formatting. However, before a bi-directional text or document is rendered on a computer screen, it is first processed by a bi-directional algorithm. The bi-directional algorithm assigns a bi-directional attribute to each character in the document and defines how characters in a single text block are displayed as a function of these attributes and a base direction of the text block.

Generally, base directionality of text blocks is marked in HTML with the “dir” attribute. Embedded tables inherit the base directionality of text blocks. That is, the “dir” attribute also marks the directionality of columns in an embedded table. For example, in a right-to-left formatted document, the left-most column of an embedded table is displayed or printed in the right-most location.

However, the bi-directional algorithm does not assign bi-directional attributes to images or icons embedded in documents. Nor do icons or images inherit the base directionality of the text blocks in which they are embedded. Consequently, embedded icons or images in a stored bi-directionally formatted document are displayed or printed in their logical order. That is, if when the document is created, an icon is placed at a particular location in a paragraph of the document, the icon will remain at that particular location when the document is displayed on a screen or printed although the words around the icon may have changed position. Note that since icons are images they will henceforth be used interchangeably.

Presently, HTML document creators have been guessing, on a trial and error basis, the location where to place an embedded image so that when the document is rendered on a screen or printed, the embedded image may be in its visual order in the document. This, ordinarily, is a time consuming and a rather frustrating endeavor.

Therefore, what is needed is an apparatus, system and method of automatically placing embedded images in their visual order in a displayed or printed bi-directionally formatted document.

### SUMMARY OF THE INVENTION

The present invention provides a system, apparatus and method of automatically placing embedded images in their visual order in a displayed or printed bi-directionally formatted HTML document. The system, apparatus and method includes assigning a directional attribute to each image tag embedded in an HTML document. Then, the HTML document is processed by a bi-directional algorithm that specifies a visual order location for each one of the tags in the HTML document. Finally, each one of the image tags is placed in the specified location before passing the HTML document to a browser to be displayed or printed.

In a particular embodiment, the method includes automatically placing a sentinel character next to each image tag. Each sentinel character has a directional attribute coinciding with the assigned directional attribute of each image tag with which it is associated. The sentinel characters are used by the bi-directional algorithm for placing the image tags in their visual order.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4(a) depicts a raw HTML document.

FIG. 4(b) is a rendition of the HTML document shown in FIG. 4(a) on a screen or on a printed medium.

FIG. 5(a) depicts part of a paragraph that consists of both English and Hebrew words where the Hebrew words are written using uppercase Latin characters.

FIG. 5(b) is a rendition of the part of the paragraph shown in FIG. 5(a) on a screen or on a printed medium.

FIG. 6(a) depicts part of the paragraph in FIG. 5(a) with an embedded icon.

FIG. 6(b) is a rendition of the part of the paragraph shown in FIG. 6(a) with the icon placed in its logical order.

FIG. 6(c) is a rendition of the part of the paragraph shown in FIG. 6(a) with the icon placed in its visual order.

FIG. 7(a) is a representative HTML image formatting code.

FIG. 7(b) is a first representative HTML image formatting code in accordance with the invention.

FIG. 7(c) is a second representative HTML image formatting code in accordance with the invention.

FIG. 7(d) is an HTML image formatting code with an added “ICON LEFT ASSOCIATIVE” sentinel character.

FIG. 7(d) is an HTML image formatting code with an added “ICON RIGHT ASSOCIATIVE” sentinel character.

FIG. 7(d) is an HTML image formatting code with an added “ICON NEUTRAL ASSOCIATIVE” sentinel character.

FIG. 8 is a flow chart of a process that may be used to implement the invention.

### DETAILED DESCRIPTION OF THE PREFERRED EMBODIMENT

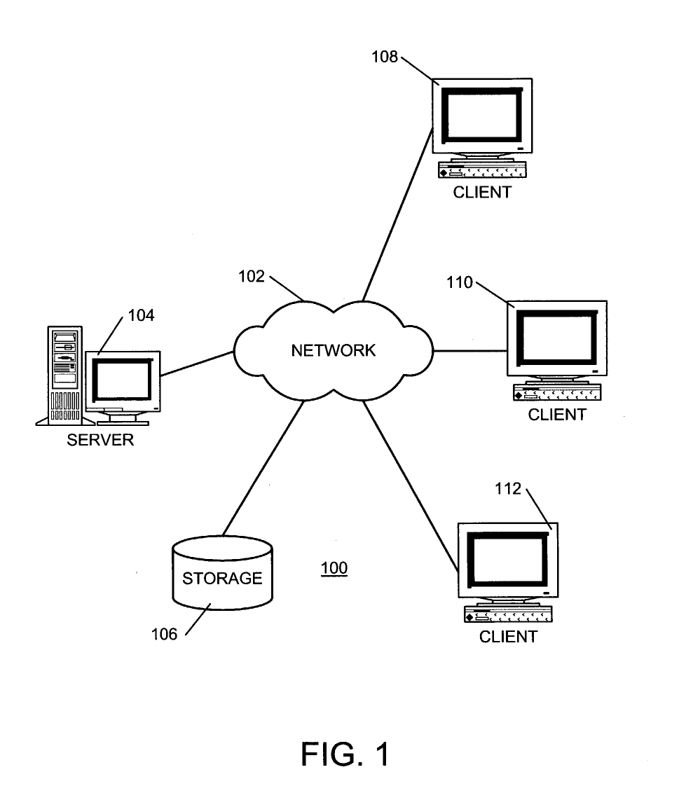

With reference now to the figures wherein like reference numeral refer to like parts, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

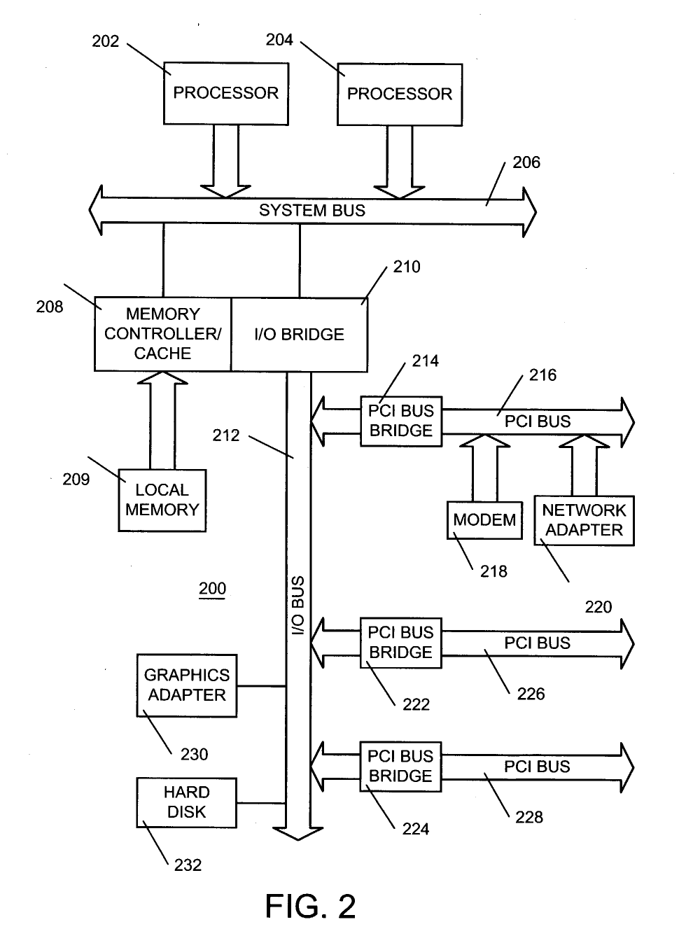

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

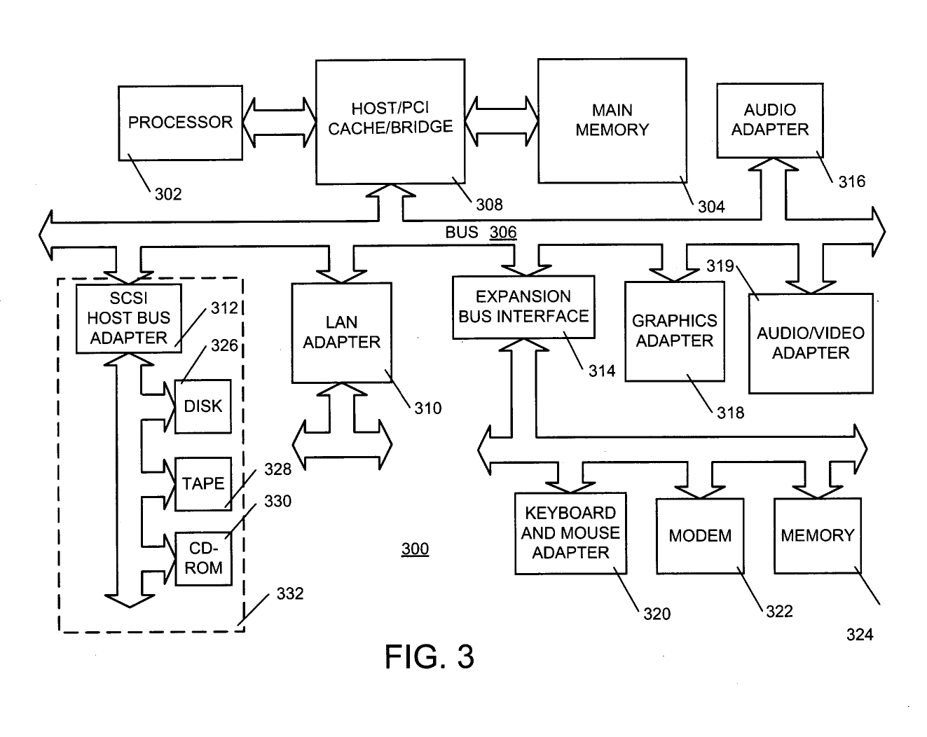

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus, system and method of automatically placing embedded images in their visual order in a displayed or printed bi-directionally formatted document. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

As mentioned above, HTML supports bi-directional text formatting. To facilitate such text formatting, however, Unicode characters are used. To explain, computers work with numbers. Thus, each character in a language is assigned a number to allow texts written in the language to be presented, edited, manipulated etc. by a computer system.

There are many different encoding systems that are used to assign numbers to characters. However, most do not contain all the different characters used by all languages, whether presently in use or not, in the world. Consequently, some of these encoding systems may conflict with one another. That is, two encoding systems may use the same number for two different characters, or use different numbers for the same character. This requires that some computers (especially servers) support many different encoding systems. In addition, documents are more and more being transmitted from one computer system to another. When doing so, a document may have to be changed from one encoding system to another. This, then, may introduce data corruption.

Unicode, on the other hand, contains or is capable of containing all the characters that are used by all the languages, whether in use or not, in the world. Thus, each character is assigned a unique number. This, then, avoids both the conflict and the corruption issues mentioned above. In addition, since some languages are written from left-to-right while some others are written from right-to-left etc., all characters are assigned a directional attribute (i.e., left-to-right, right-to-left, etc.). Characters that do not have a directional attribute are referred to as neutral characters and include space, insert, delete etc.

In formatting bi-directional text in HTML, certain rules are to be followed. For example, the default directionality of HTML text is left-to-right. Therefore, if HTML text is being written in a bi-directional language such as Hebrew or Arabic, it may be necessary that the overall direction of the HTML text be specified as right-to-left.

One may further specify the directionality of each paragraph in a document. If the directionality of a paragraph is not specified, the paragraph will inherit the directionality of its parent. If its parent is the overall document and the parent's directionality is left-to-right, either by default or by design, the paragraph's directionality will also be left-to-right.

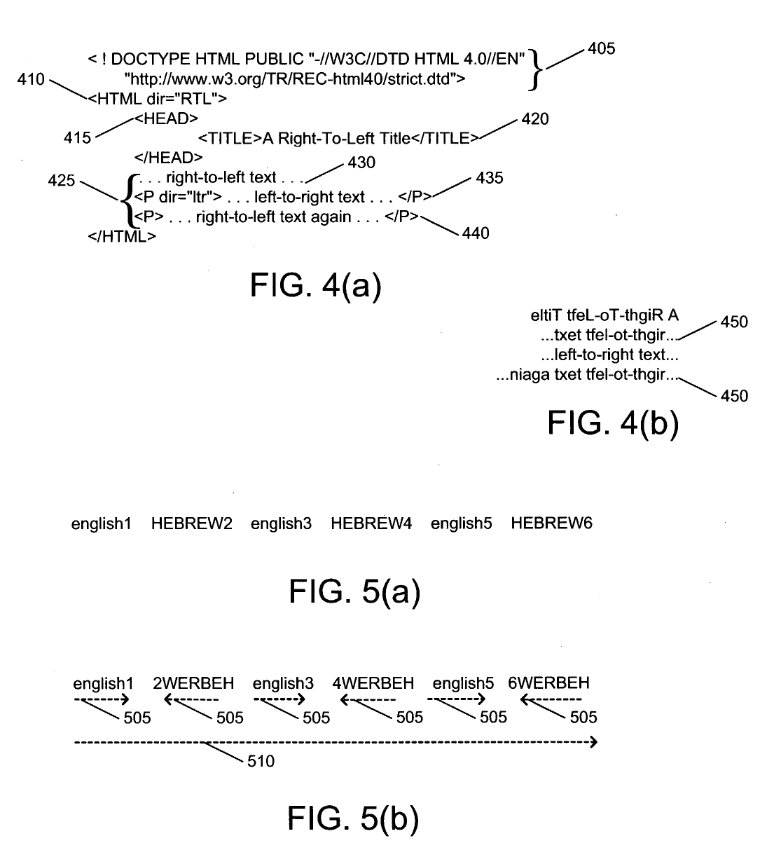

FIG. 4(a) depicts a raw HTML document. An HTML document consists of text and tags that mark the structure of the document. Elements in an HTML document are delimited by the tags which include “1<” and “>”. Some elements have both a start and end tag (e.g., <TITLE> and </TITLE>). Others may only use a single tag (e.g., <P> (the paragraph element)). Some elements have attributes, which are qualifications of the element's meaning or optional parameters for that element. Further, every HTML document must at least include a descriptive title element. More generally, documents can start with a <!DOCTYPE> declaration followed by an HTML element containing a HEAD and a BODY element.

Lines 1 and 2 of FIG. 4(a), referred to as element 405, have the <!DOCTYPE> declaration. There, the version of the HTML (i.e., version 4.0) that is used to format the document and the location where the Document Type Declaration (DTD) is stored are stated. A DTD defines the syntax and usage of the HTML document. It is a good practice to have an HTML document adhered to a DTD to ensure that there are no instances of misused elements or tags in the document.

The third line in the document (i.e., line 410) has an HTML element. The HTML element has a “dir” attribute. This “dir” attribute indicates the overall directionality of the document. In this case, the overall directionality is right-to-left. The document also includes a TITLE element 420 within a HEAD element 415 and a body 425.

The body 425 of the document may be made of one or a plurality of paragraphs. In this particular case, the HTML document has three paragraphs, paragraphs 430, 435 and 440. Paragraphs 430 and 440 do not have a “dir” attribute and hence inherit their directional attribute from the overall document. Since the overall directionality of the document is right-to-left as stated in line 410, then the directionality of paragraphs 430 and 440 is right-to-left. By contrast, the directionality of paragraph 435 is specifically stated as left-to-right.

FIG. 4(b) is a rendition of the HTML formatted document shown in FIG. 4(a) on a screen or on a printed medium. Note that because the overall directionality of the document is right-to-left, the document is rendered on a screen or printed on the medium from the right margin. Note also that right-to-left texts (i.e., texts 450) that were typed in the computer system in their logical order are rendered or printed in their visual order.

Although a paragraph may have its own directionality, the characters in each word within the paragraph determine the directionality of the words. FIG. 5(a) depicts part of a paragraph that consists of both English and Hebrew words where the Hebrew words are represented using uppercase Latin characters. Suppose the paragraph is entered into the computer system as shown (i.e., in its logical order). Further, since English is a left-to-right language and Hebrew, as far as letters are concerned, is a right-to-left language, the inherent directional attribute of the English words is left-to-right whereas that of the Hebrew words is right-to-left. Consequently, the paragraph will be rendered or printed as shown in FIG. 5(b). The direction of each arrow 505 indicates the direction of each word with which it is associated. Arrow 510, on the other hand, indicates the overall directionality of the paragraph. In this instance, the overall directionality of the paragraph is left-to-right.

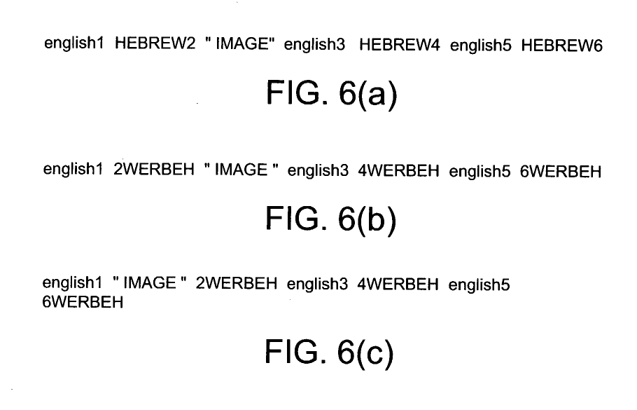

Now, suppose an image is inserted between HEBREW2 and english3 as shown in FIG. 6(a). Then since, as mentioned before, images do not have directional attributes, the inserted image will be rendered at the same location it was inserted in the paragraph (i.e., in its logical order). That is, the inserted image will be rendered between 2WERBEH and english3. However, if the HTML document creator wanted the inserted image to be rendered in front of 2WERBEH as shown in FIG. 6(c), the creator would have to manually insert the image in front of the word HEBREW2.

The present invention proposes to use a “dir” attribute with each embedded image. The present invention further proposes the introduction of three Unicode characters to be used as sentinels to indicate the logical position of the embedded images within an HTML document. Each one of these characters will be defined within the Unicode Private Use Area character section. The Private Use Area character section goes from code points U+E000 to U+F8FF, where U+is used to designate Unicode code point. A code point is a code or number used to represent a Unicode character.

The three code points are: U+E000 (decimal 57344), U+E001 (decimal 57345) and U+E002 (decimal 57346). Each one of these characters will be assigned a Unicode directional property. For example, U+E000 will be given a STRONG LEFT direction, U+E001 a STRONG RIGHT direction and U+E002 a NEUTRAL direction. Consequently, Code point U+E000 may be referred to as an “ICON LEFT ASSOCIATIVE”. Code point U+E002, on the other hand, may be referred as an “ICON RIGHT ASSOCIATIVE” whereas U+E002 may be referred as an “ICON NEUTRAL ASSOCIATIVE”.

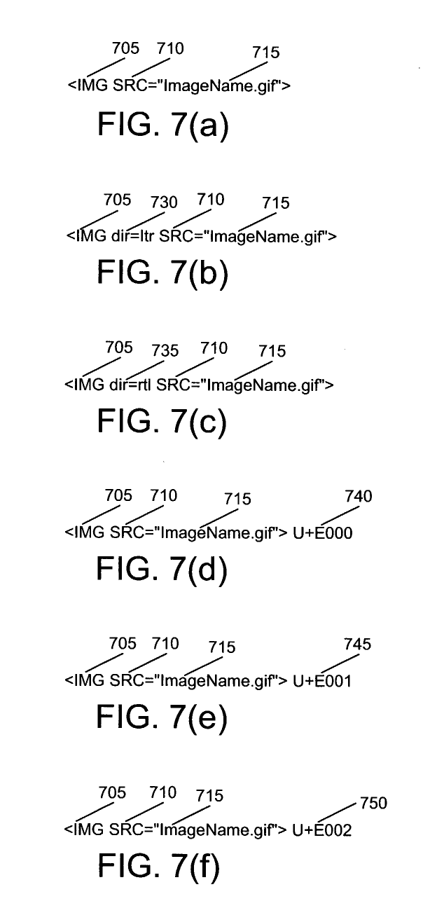

FIG. 7(a) is a representative HTML image formatting code. To indicate that an image is being inserted, the tag IMG 705 is used. The attribute SRC 710 is used to indicate the location of the image to be inserted. ImageName.gif 715 is the actual name of the image including its pathname.

According to the invention, if an image is to be associated with a left-to-right text, the attribute dir=ltr 730 will be inserted between the IMG tag 705 and the SRC attribute 710 as shown in FIG. 7(b). Conversely, if the image is to be associated with a right-to-left text, the attribute dir=rtl 735 will be inserted between the IMG tag 705 and the SRC attribute 710 as shown in FIG. 7(c). If however, the directionality of the image is unimportant, the dir attribute may be left off as in FIG. 7(a).

When a bi-directional HTML document is loaded to be rendered on a computer screen or to be printed, the source document is scanned for all image tags that may be embedded therein. For each image tag found, a check is made for the existence of the directional attribute of the image. If a directional attribute is found and it is left (i.e., ltr), then an “ICON LEFT ASSOCIATIVE” sentinel character represented by code point 740 is inserted after the image tag as shown in FIG. 7(d). If the attribute is right (i.e., rtl), then an “ICON RIGHT ASSOCIATIVE” sentinel character represented by code point 745 is inserted after the image tag (see FIG. 7(e)). If there is not a directional attribute, then an “ICON NEUTRAL ASSOCIATIVE” sentinel character represented by code point 750 is inserted after the image tag (see FIG. 7(f)).

After the document has been scanned, it is passed through a Unicode bi-directional algorithm. The Unicode bi-directional algorithm will then put the icon associative characters in their visual order. Once done, each character is replaced by the image with which it is associated. Note that there exists a plurality of bi-directional algorithms (e.g., Haskell bi-directional algorithm, Unicode bi-directional algorithm, pretty good bi-directional algorithm, free bi-directional algorithm etc.). Any one of the bi-directional algorithms may be used. However, the Unicode bi-directional algorithm is used to explain the invention.

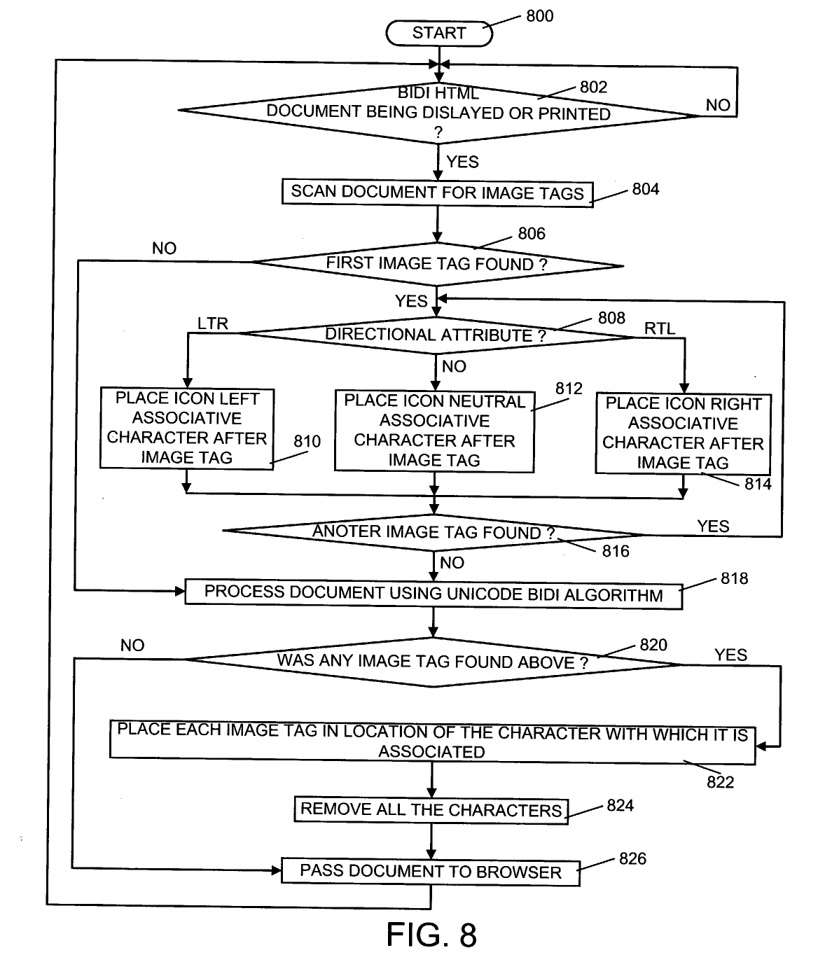

FIG. 8 is a flow chart of a process that may be used to implement the invention. To use the process, however, the creator of a bi-directionally formatted HTML document must have formatted the document such that each embedded image has a directional attribute. Further, Unicode characters (e.g., U+E000, U+E001, and U+E002) must have been set aside to be used as sentinels for the directional attributes of the images.

The process starts when a computer system within which the process is installed is turned on or refreshed (step 800). Then a check is continuously being made to determine whether an HTML document is being accessed (step 802). If so, the document is scanned for embedded image tags (step 804). If no image tag is found, the process jumps to step 818 for the document to be processed by a bi-directional algorithm before being passed to the browser (steps 806, 818, 820 and 826). After passing the HTML document to the browser, the process returns to step 802.

If there are image tags, then, for each image tag found, the directional attribute assigned to the image is determined. If the directional attribute assigned to the image tag is determined to be left-to-right, an “ICON LEFT ASSOCIATIVE” sentinel character is placed after the image tag. If the directional attribute assigned to the image is determined to be right-to-left, then an “ICON RIGHT ASSOCIATIVE” sentinel character is placed after the image tag. If there is not a directional attribute assigned to the image tag, an “ICON NEUTRAL ASSOCIATIVE” sentinel character is instead placed after the image tag (steps 806-816).

After scanning the HTML document, the document is processed using a bi-directional algorithm (step 818). As mentioned before, the purpose of this algorithm is to ensure that a bi-directionally formatted document that has been created in a logical order is rendered in its visual order. Hence, each sentinel character (which itself contains a directional attribute) placed after an image tag will be placed in its visual order.

Then the process moves each image tag to the location where its associated sentinel character was placed by the bi-directional algorithm (steps 820 and 822). After doing so, all the sentinel characters are removed before the HTML document is passed to the browser (steps 824 and 826). After passing the HTML document to the browser, the process returns to step 802.

The description of the present invention has been presented for purposes of illustration and description, and is not intended to be exhaustive or limited to the invention in the form disclosed. Many modifications and variations will be apparent to those of ordinary skill in the art. For example, many other Unicode characters within the Private Use Area character section or otherwise, may instead be used. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of automatically placing embedded images in their visual order in a displayed or printed bi-directionally formatted HTML document comprising the steps of:
assigning a directional attribute to an image tag embedded into an HTML document;
processing the HTML document using a bi-directional algorithm for automatically specifying a location, based on the assigned directional attribute, where the image tag is to be placed in the HTML document, the location being in a visual order or an order in which the image tag is to be displayed or printed;
placing the image tag in the specified visual order location; and
passing the HTML document to a browser to be displayed or printed.

2. The method of claim 1 wherein the processing step includes the step of automatically placing a sentinel character next to the image tag before the document is processed by the bi-directional algorithm, the sentinel character having a directional attribute coinciding with the assigned directional attribute enabling the bi-directional algorithm to place the image tag in the visual order location.

3. The method of claim 2 wherein the sentinel character is removed after the image tag is placed in the visual order location.

4. The method of claim 3 wherein the HTML document, when accessed, is scanned for each image tag embedded therein and a directional attribute is assigned to each embedded image tag.

5. The method of claim 4 wherein the formatted directional attribute is a left-to-right, right-to-left or neutral attribute.

6. The method of claim 5 wherein the sentinel character is an unused Unicode character.

7. A computer program product on a computer readable medium for automatically placing embedded images in their visual order in a displayed or printed bi-directionally formatted HTML document comprising:
code means for assigning a directional attribute to an image tag embedded into an HTML document;
code means for processing the HTML document using a bi-directional algorithm for automatically specifying a location, based on the assigned directional attribute, where the image tag is to be placed in the HTML document, the location being in a visual order or an order in which the image tag is to be displayed or printed;
code means for placing the image tag in the specified visual order location; and
code means for passing the HTML document to a browser to be displayed or printed.

8. The computer program product of claim 7 wherein the processing code means includes code means for automatically placing a sentinel character next to the image tag before the document is processed by the bi-directional algorithm, the sentinel character having a directional attribute coinciding with the assigned directional attribute enabling the bi-directional algorithm to place the image tag in the visual order location.

9. The computer program product of claim 8 wherein the sentinel character is removed after the image tag is placed in the visual order location.

10. The computer program product of claim 9 wherein the HTML document, when accessed, is scanned for each image tag embedded therein and a directional attribute is assigned to each embedded image tag.

11. The computer program product of claim 10 wherein the formatted directional attribute is a left-to-right, right-to-left or neutral attribute.

12. The computer program product of claim 11 wherein the sentinel character is an unused Unicode character.

13. An apparatus for automatically placing embedded images in their visual order in a displayed or printed bi-directionally formatted HTML document comprising:
means for assigning a directional attribute to an image tag embedded into an HTML document;
means for processing the HTML document using a bi-directional algorithm for automatically specifying a location, based on the assigned directional attribute, where the image tag is to be placed in the HTML document, the location being in a visual order or an order in which the image tag is to be displayed or printed;
means for placing the image tag in the specified visual order location; and
means for passing the HTML document to a browser to be displayed or printed.

14. The apparatus of claim 13 wherein the processing means includes means for automatically placing a sentinel character next to the image tag before the document is processed by the bi-directional algorithm, the sentinel character having a directional attribute coinciding with the assigned directional attribute enabling the bi-directional algorithm to place the image tag in the visual order location.

15. The apparatus of claim 14 wherein the sentinel character is removed after the image tag is placed in the visual order location.

16. The apparatus of claim 15 wherein the HTML document, when accessed, is scanned for each image tag embedded therein and a directional attribute is assigned to each embedded image tag.

17. The apparatus of claim 16 wherein the formatted directional attribute is a left-to-right, right-to-left or neutral attribute.

18. The apparatus of claim 17 wherein the sentinel character is an unused Unicode character.

19. A system for automatically placing embedded images in their visual order in a displayed or printed bi-directionally formatted HTML document comprising:
at least one storage device for storing code data; and
at least one processor for processing the code data to assign a directional attribute to an image tag embedded into an HTML document, to process the HTML document using a bi-directional algorithm for automatically specifying a location, based on the assigned directional attribute, where the image tag is to be placed in the HTML document, the location being in a visual order or an order in which the image tag is to be displayed or printed, to place the image tag in the specified visual order location, and to pass the HTML document to a browser to be displayed or printed.

20. The system of claim 19 wherein the processor further processes the code data to automatically place a sentinel character next to the image tag before the document is processed by the bi-directional algorithm, the sentinel character having a directional attribute coinciding with the assigned directional attribute enabling the bi-directional algorithm to place the image tag in the visual order location.

21. The system of claim 20 wherein the sentinel character is removed after the image tag is placed in the visual order location.

22. The system of claim 21 wherein the HTML document, when accessed, is scanned for each image tag embedded therein and a directional attribute is assigned to each embedded image tag.

23. The system of claim 22 wherein the formatted directional attribute is a left-to-right, right-to-left or neutral attribute.

24. The system of claim 23 wherein the sentinel character is an unused Unicode character.
